(19) United States
(12) Patent Application Publication
(10) Pub. No.: US 2025/0285142 A1
(43) Pub. Date: Sep. 11, 2025

(54) SYSTEMS AND METHODS FOR SELECTING MULTIMEDIA CONTENT BASED ON CONTRAST

(71) Applicant: Adeia Guides Inc., San Jose, CA (US)

(72) Inventors: Aldis Sipolins, Somerville, MA (US); Ning Xu, Irvine, CA (US); Tao Chen, Palo Alto, CA (US); Serhad Doken, Bryn Mawr, PA (US)

(21) Appl. No.: 18/597,441

(22) Filed: Mar. 6, 2024

(51) Int. Cl. G06Q 30/0251; G06Q 30/0242

(52) U.S. Cl. CPC G06Q 30/0269; G06Q 30/0244

(57) ABSTRACT

Systems and methods are provided herein for determining and selecting content based on associated media items. The disclosed systems and methods analyze media items (e.g., media posts) and determine whether content items (e.g., advertisements) with high contrast or low contrast should be selected to be displayed. For example, a content provider (e.g., an advertiser or advertising campaign manager) indicates that it prefers its content items to exhibit highly contrasting features relative to nearby media items. In such embodiments, the disclosed systems and methods analyze features of the nearby media items and select a content item that contrasts with those features. Conversely, if the content provider indicates that it prefers its content items to blend in with nearby media items, the disclosed systems and methods select a content item that exhibits low contrast with respect to those features.

### BACKGROUND

The present disclosure relates to displaying multimedia content, and in particular to systems and methods for selecting multimedia content based on contrast and other parameters.

### SUMMARY

Modern media providers typically embed advertisements and other content among media. Advertisers expend resources to develop advertising campaigns. Some campaigns rely on advertisements standing out amongst displayed media from the media providers. Other advertising campaigns are designed to blend in with the displayed media.

For example, social media content (both advertisements and posts) struggles to stand out when surrounded by similar posts. In some cases, advertisers would prefer to ensure high contrast (i.e., large variance) as compared to preceding and subsequent posts to make their advertisements stand out from surrounding posts. In other cases, advertisers may prefer low contrast advertisements to fit in with non-sponsored posts and thus not stand out as an advertisement. Presently available social media algorithms are unable to ensure high or low contrast between images or between mixed-media posts because they simply do not consider previous and subsequent posts when selecting and inserting advertisements among other media.

Contrast can apply to many different modalities: visual (e.g., color, composition, font size, font style, shading, boarders, reflections, backgrounds, etc.), auditory (e.g., volume, music style), tone (e.g., positive or negative), and even format (e.g., video, text, image, text-on-image). Current approaches to advertising (e.g., social media advertising) do not consider visual features of posts or higher-order features such as format or tone. Currently, advertisements are served based on the user's identified interests and whether they fit in the advertiser's target demographic. Not considering contrast makes social media feed advertisements less effective and negatively impacts user experience.

When deciding what post(s) to display in a social media feed, certain techniques of the present disclosure identify features of preceding and/or subsequent posts such as format, dominant color, and tone. For each feature, predominance is identified and whether high or low contrast is desired. Focusing on predominant features, if high contrast is desired (e.g., to make an advertisement stand out), content (e.g., an advertisement) is selected with high contrast compared to previous and subsequent media. If low contrast is desired (e.g., to make an advertisement appear like a non-advertisement post), content with low contrast is selected compared to previous and subsequent posts with similar features.

Techniques of the present disclosure can be applied to ensure high or low contrast, or even contrasting levels of contrast for different features. Some techniques may be applied to content items (e.g., advertisements) as well as media items (e.g., user posts). Some techniques can be applied to scrolling feeds (e.g., Twitter, Instagram, Facebook) as well as full-screen media items (e.g., TikTok, IG Reels). The techniques of the present disclosure are not limited to mobile device implementations—the techniques described herein can be applied to web-based applications and/or applications implemented at other device (e.g., computers, tablets, televisions, wearable technology devices). The techniques of the present disclosure improve the effectiveness of social media advertisements, as well as user experience. Whether the advertisement campaign is directed to high or low contrast advertising may be specified by the demand side platform (DSP) to service side platform (SSP). Such parameters may be used during the real-time bidding (RTB) process to determine the best advertisement for the content feed.

In an implementation, techniques of the present disclosure include retrieving metadata relating to media items (e.g., social media posts in a social media feed) using, for example, an application programming interface (API). Content provider (e.g., advertiser) preferences may include those that determine which metadata features are retrieved. Multimedia to be analyzed may include a prespecified number of images, images from a pre-determined timeframe, or may be limited to what is currently displayed on the user device. In such an implementation, content that is partly visible on the user device (e.g., cut off from view) may be weighted based on how much content is visible or not visible. After retrieving available metadata, any missing features may be set to a default or neutral value, or identified using, for example, existing techniques (e.g., sentiment analysis, dominant color extraction). In some embodiments, the techniques of the present disclosure consider features that are not visible because such features may nevertheless implicate certain content provider preferences. In such cases, the missing features are included.

Some features of the present disclosure may be associated with a particular approach (e.g., predefined) for calculating predominance. When analyzing dominant colors for example, the percentage of image occupied by a particular dominant color may be an effective predominance measure. Sentiment intensity may similarly serve as a predominance measure for sentiment analysis. One example of measuring format may be the word count or character count appearing in, for example, an image or frames of a video clip. In such an example, the total word count or character count displayed during a unit of time (e.g., 3 seconds). Although a specific unit of time may be described, any unit of time (including zero) may be implemented without departing from the contemplated implementations. In another implementation, determining predominance of text, audio, image, and/or video features applies a pertained large foundation model, for example, GPT4 or GPT4V, and provide a list of attributes that the system evaluates, for example, color, sentiment, etc. The system may then query the foundation model regarding the content, for example, querying the predominant color of displayed images.

In a video implementation, predominance may be an average or normalized count in a unit of time. The word count or character count may be replaced or combined with the area where the text appears or covers (e.g., the area occupied by text or symbols). Text may be presented in different font styles and sizes, and thus altogether take up different space and positioning in the visual. Additionally, text emphasis may be considered. In such an example, techniques of the present disclosure may consider the font size and color relative to other nearby characters. In such an example, the size, shape, color, or display of text (e.g., whether it is italicized, underlined, or emboldened) is considered in determining the dominance. In some implementations, the addition or insertion of words and/or text is adjusted to represent a desired predominance score. Features that do not have an associated predominance calculation method may be considered to have average predominance scores, or they may not be associated with any predominance score. Predominance scores, which can be vectors of varying dimensions for various features, may be associated with an equation to standardize values or a range of values to enable standardization using existing methods (e.g., Z scores) to enable comparisons between features with different scales.

| Feature | Example Predominance Measure |
|---|---|
| Dominant Color | Percent of pixels with that specific color or |
| | similar colors |
| Tone | Sentiment intensity |
| Content | Percent of image occupied by recognized object |
| | (e.g., a cat), classification confidence |
| Format | Percent of image occupied by recognized format |
| | (e.g., text vs. image), classification confidence |
| Composition | Percent of image taken up by recognized composition |
| | (e.g., close-up, landscape, audio), classification |
| | confidence |

In some implementations, some of the detected features are disregarded where their impact is negligible. For example, detected features may be disregarded to eliminate features with predominance scores below a threshold value to focus on those favored by content providers (e.g., advertisers). Such a threshold may be predetermined, user or content provider specified, dynamically adjusted, or fixed. For each feature, content providers (e.g., advertisers) may indicate whether their advertising approach is to exhibit a high or low contrast relative to a particular feature(s). Advertisers may also indicate conditional contrast based on other features. For example, if a potential advertisement has low color contrast with surrounding media, the advertiser may wish to ensure high content contrast. In such an example, if an advertisement contains a cat and is surrounded by media with cats, the advertiser may wish to ensure low content contrast to appeal to the user. In such an example, the advertiser may further specify that the advertisement have low subject matter contrast (i.e., placing an advertisement having a cat among content related to or featuring cats) while having high visual contrast (i.e., the advertisement including a cat but includes highly contrasting colors and/or brightness as compared to surrounding content). In this way, techniques of the present disclosure allow content providers the ability to distinguish certain aspects of content items (e.g., advertisements) while maintaining continuity and congruency with other aspects of advertisements.

In some implementations, the techniques of the present disclosure consider user preferences when determining which aspect of content items (e.g., advertisements) to adjust. In such implementations, user preferences influence the desired contrast for each feature, whether predetermined (e.g., user specified) or determined by the system (e.g., based on historical user information). In such implementations, such preferences may be detected using clickstream data or manually indicated by the user (e.g., by manually setting or determining user preferences). For example, when a content item is inserted after media containing a cat and the content provider has indicated the content item should have high content contrast, the content item may not contain a cat. However, if the user has expressed an affinity for cats (e.g., by manual indication or system determination), techniques of the present disclosure may adjust the desired content contrast to match the user's preferences. That is, techniques of the present disclosure may determine which aspects of an advertisement to have high- or low-contrast based on determined attributes of the user. Continuing with the previous example, since the user has been determined to have a particularly high affinity for cats, the techniques herein may adjust other aspects of the advertisement (e.g., color, tone, format, composition, etc.) while maintaining the same content (e.g., cats), despite the content provider's indication that only high contrast content items are to be selected and displayed. In this way, the techniques of the present disclosure better align advertising campaigns with user preferences even where they would typically be at odds with one another.

In another example, a user may exhibit a strong preference for content with a sarcastic tone. In such an example, even if advertisers indicate a desire for high-contrast content, techniques of the present disclosure may keep the user-preferred sarcastic tone while incorporating high contrast into less preferred features.

Additionally, features of the present disclosure may consider political, religious, social, or sporting affinities. In an example implementation, the user has indicated a particular affinity for Ohio State Football. The system determines supporters of Ohio State Football largely shun University of Michigan football (i.e., Ohio State University and University of Michigan are known to exhibit an extremely deep-rooted rivalry in collegiate American football). In such an example, the system may determine that, although the user has expressed a particular desire to experience positive, uplifting media and content, that user may nevertheless enjoy and engage with media and content that disparages all things related to University of Michigan football. Various approaches may be similarly applied to religious, political, or social preferences.

After determining the features with corresponding predominance, content provider (e.g., advertiser) preferences, and user preferences, a potential content item (e.g., advertisement) that best fits the desired contrast for each feature is identified. In some implementations, advertisers may provide alternate versions of advertisements or advertisements with adjustable features. In such an implementation, potential advertisements with adjustable values are identified. Certain values may be systematically changed to identify which combination of values produces the most desirable contrast across features, and in some implementations, the values weighted by advertiser and user preferences. In an exemplary implementation, if color intensity is an adjustable feature of an advertisement, the highest and lowest values (e.g., 0 and 100) are selected in a pre-approved range. N-2 number of evenly spaced intervals are selected between the values (e.g., N=5 corresponds to values of 0, 25, 50, 75, and 100). The value of N may be manually indicated by the user, suggested or determined by the system, or limited by other factors (e.g., device or bandwidth constraints).

Adjustable feature values may also be pre-selected. For example, a content provider (e.g., advertiser) may indicate a certain color saturation (e.g., black and white, full color, and 25% color, etc.). For every possible value for an adjustable feature, the system may keep it constant while similarly adjusting all other adjustable feature values. Such an implementation limits the computational burden of processing multiple features with continuous values.

Once the advertisement has been selected, subsequent content to ensure a desired or preferred contrast on relevant features may be selected. In such an implementation, the identified features with corresponding predominance values of preceding posts may be used to guide selection of subsequent content. The amount of contrast to the preceding posts may vary within a range and may increase or decrease over time, which can be set by a user or the system. For example, a user may specify the display of high contrast content every 10 minutes or every 10 content segments (e.g., posts), with low contrast content being presented otherwise. In other implementations, techniques of the present disclosure to determine preceding content to match advertisement preferences for a specific advertisement. In such an implementation, an advertiser may specify that a specific advertisement is to be displayed and the system may determine certain content to display such that the specified advertisement meets the criteria for its display in relation to the preceding content. In this way, techniques of the present disclosure tailor preceding or surrounding content to ensure certain advertisements are displayed within certain advertising constraints.

Accordingly, systems and methods are described herein for selecting content items based on contrast. In an example implementation, the disclosed systems and methods receive media information related to a plurality of media items for display at a user device. In some implementations, such information is retrieved from a database. The disclosed systems and methods determine a set of feature attributes for each media item of the plurality of media items. In some implementations, such determination is based on the received media information. The systems and methods disclosed herein receive (e.g., from a content provider) a contrast indicator that relates to a feature attribute of the set of feature attributes. The disclosed systems and methods select a content item. In some implementations, the selection is based on the set of feature attributes and the contrast indicator. The disclosed systems and methods display the selected content item and a media item of the plurality of media items.

In some implementations, the feature attribute of the set of feature attributes relates to a modality selected from the group consisting of color, context, format, sentiment, tone, and composition.

In some implementations, a feature attribute of the set of feature attributes relates to a color profile of the plurality of media items. In such implementations, the received contrast indicator is associated with high contrast and the selected content item comprises a content color profile that is distinct from the color profile of the plurality of media items.

In some implementations, a feature attribute of the set of feature attributes relates to a color profile of the plurality of media items. In such implementations, the received contrast indicator is associated with low contrast and the selected content item comprises a content color profile that is similar to the color profile of the plurality of media items.

In some implementations, the systems and methods further determine a predominance score for each feature attribute of the set of feature attributes. In some implementations, the systems and methods further rank the plurality of media items based on the determined predominance score.

In some implementations, the systems and methods described herein retrieve user preferences from a database. In such implementations, selecting the content item is further based on the user preferences.

In some implementations, the user preferences include historical user information associated with the user device.

In some implementations, the disclosed systems and methods determine a feature attribute score for each feature attribute of the set of feature attributes. In some implementations, each feature attribute is ranked according to the determined feature attribute score.

In some implementations, the disclosed systems and methods receive a second contrast indicator that relates to a second feature attribute of the set of feature attributes. In some implementations, the second contrast indicator is retrieved from the content provider. In some implementations, selecting the content item is further based on the second contrast indicator.

In some implementations of the present disclosure, the first contrast indicator and the second contrast indicator relate to different modalities of feature attributes.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 depicts an illustrative diagram of a system for selecting multimedia content based on contrast, in accordance with embodiments of the disclosure;

FIG. 2 depicts an illustrative diagram of a system for selecting multimedia content based on contrast, in accordance with embodiments of the disclosure;

FIG. 3 depicts an illustrative diagram of a system for selecting multimedia content based on contrast, in accordance with embodiments of the disclosure;

FIG. 4 depicts an illustrative process of a system for selecting multimedia content based on contrast, in accordance with embodiments of the disclosure;

FIG. 5 depicts an illustrative diagram of a system for selecting multimedia content based on contrast, in accordance with embodiments of the disclosure;

FIG. 6 depicts an illustrative diagram of a system for selecting multimedia content based on contrast, in accordance with embodiments of the disclosure;

FIGS. 7A and 7B depict an illustrative diagram of a system for selecting multimedia content based on contrast, in accordance with embodiments of the disclosure; and

FIG. 8 depicts an illustrative diagram of a system for occupant and lane sensitive navigation, in accordance with embodiments of the disclosure.

### DETAILED DESCRIPTION

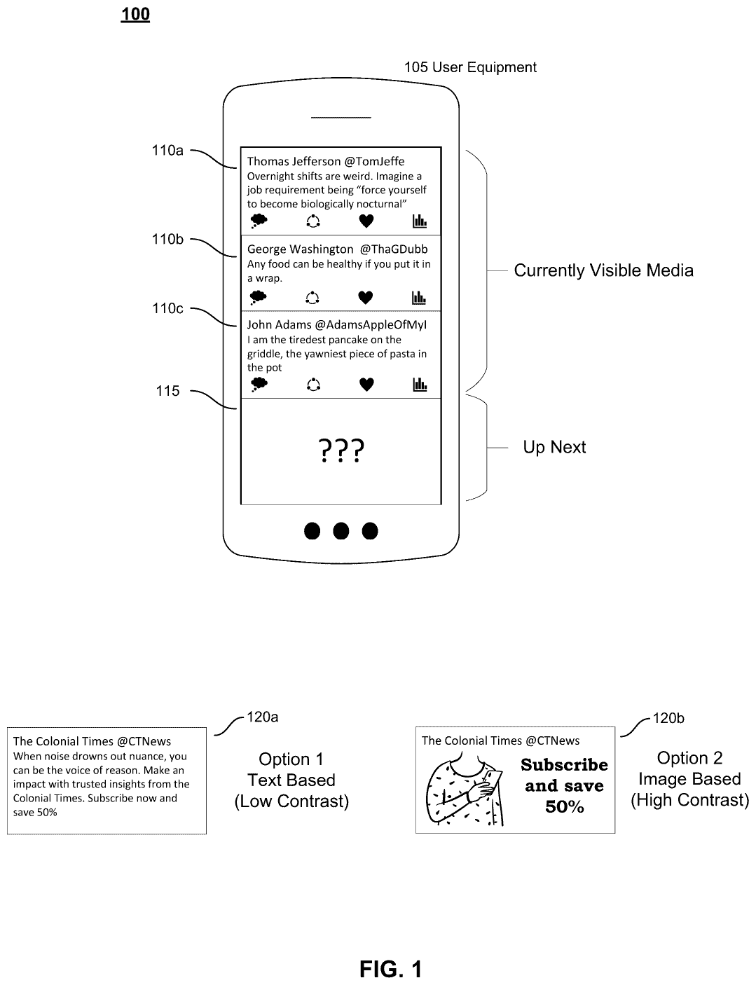

In an exemplary embodiment of the present disclosure and with reference to FIG. 1, a system for selecting multimedia content based on contrast 100 includes user device 105 having a display with media 110. Although user equipment 105 is illustrated and described as a cellular telephone, user equipment 105 may be embodied by any type of user device without departing from the contemplated embodiments. For example, user equipment 105 may be embodied by any type of device including a cellular telephone, a mobile telephone, a tablet, a laptop computer, a computer, or a smartwatch (or other wearable technological device), without departing from the contemplated embodiments.

Although, media 110 is illustrated and described as social media posts, media 110 may be embodied by any type of multimedia without departing from the contemplated embodiments. For example, media 110 may be embodied by social media posts, pictures, images, videos, or any combination thereof without departing from the contemplated embodiments. Additionally, media 110 may be displayed via a native application implemented at user equipment 105 (e.g., a built-in multimedia application) or via a third-party application (e.g., a social media application) implemented in whole or in part at user equipment 105. Additionally, although three media posts 110a-c are illustrated, user equipment 105 may display any number of media posts without departing from the contemplated embodiments.

As illustrated, user equipment 105 displays media posts 110a-c. In such an embodiment, system 100 determines which content option to display at content slot 115. [[better name than content slot]]. Optional content 120a (Option 1) is illustrated as a text-based advertisement by the Colonial Times while optional content 120b (Option 2) is illustrated as a image-based advertisement. System 100 determines whether to display Option 1 or Option 2 based on input from the provider of optional content 120; as illustrated, the advertiser Colonial Times. In such an embodiment, system 100 retrieves an indication as to whether the content slot 115 is to be occupied by a advertisement with high contrast or low contrast. Optional content 120a (Option 1) is an example of a low contrast post because it is a text-based post and displayed media 110a-c are text-based posts. Optional content 120b (i.e., Option 2) is an example of a high contrast post because it is image-based while displayed media 110a-c are text-based. Thus, if the advertiser (i.e., the Colonial Times) indicates that its advertisements are to be low contrast, system 100 selects optional content 120a (i.e., Option 1) to display in content slot 115. Conversely, if the advertiser (i.e., the Colonial Times) indicates that its advertisements are to be high contrast, system 100 selects optional content 120b (i.e., Option 2) to display in content slot 115.

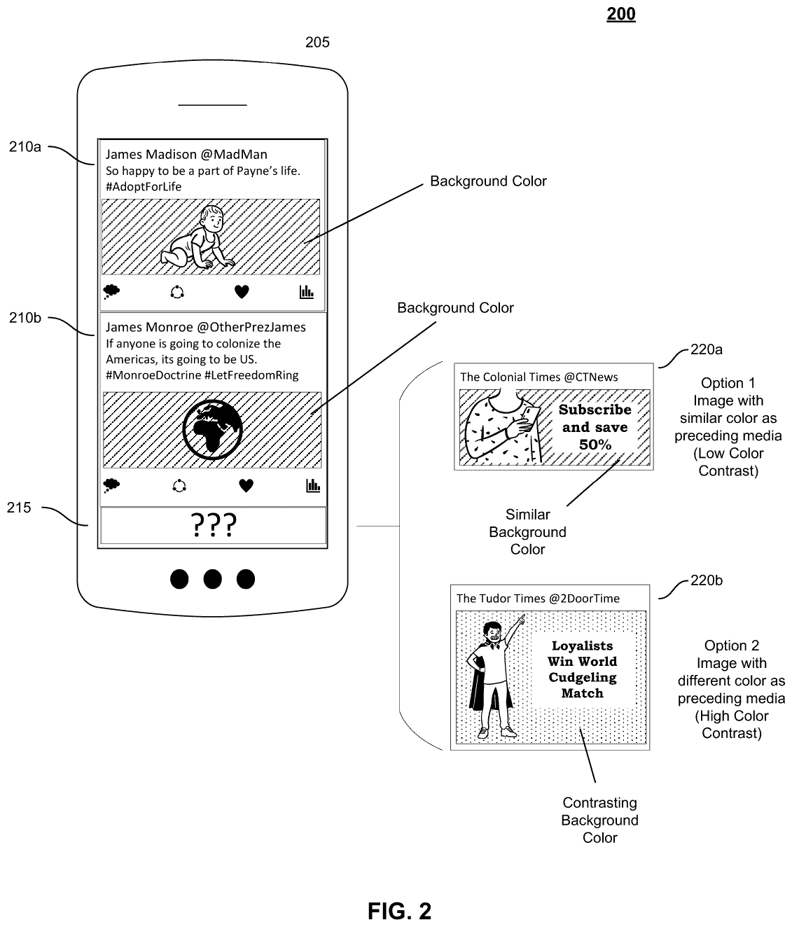

In another exemplary embodiment of the present disclosure and with reference to FIG. 2, a system for selecting multimedia content based on contrast 200 includes user device 205 having a display with media 210 displayed thereon. Although user equipment 205 is illustrated and described as a cellular telephone, user equipment 105 may be embodied by any type of user device without departing from the contemplated embodiments. As illustrated, media 210a, b are embodied by posts that contain both images and text. In this case, although displayed media 210a. b includes both images and text, system 200 classifies media 210a, b as image-based because, e.g., the text pertains to the images displayed by media 210a, b. Additionally, media 210a, b contain similar background colors, as illustrated with the same crosshatch pattern. System 200 may apply various techniques to analyze and a determine various aspects of media 210a, b, as discussed herein.

System 200 determines whether to insert content 220a or 220b. In an embodiment, system 200 receives an indication that a content item having low contrast as compared to preceding media should be selected. In such an embodiment, system 200 selects optional content 220a (i.e., Option 1 having similar color as preceding media posts 210a, b). In another embodiment, system 200 receives an indication that a content item having high contrast as compared to preceding media should be selected. In such an embodiment, system 200 selects optional content 220b (i.e., Option 2 having a different color than preceding media posts 210a, b). Although, the illustrated optional content items 220a and 220b predominantly content images for simplicity, optional content items 220a, b may contain any type of multimedia without departing from the contemplated embodiments. Additionally, although media 210a, b are illustrated as displayed above and preceding optional content slot 215, media 210a, b may have any orientation (in both special and/or temporal orientations) relative to optional content slot 215 without departing from the contemplated embodiments. For example, optional content slot 215 may be placed above, below, to the left of, to the right or, or in between media 210a and 210b (special orientation), or may be presented before, during, or after media 210a, 210b (temporal orientation), without departing from the contemplated embodiments.

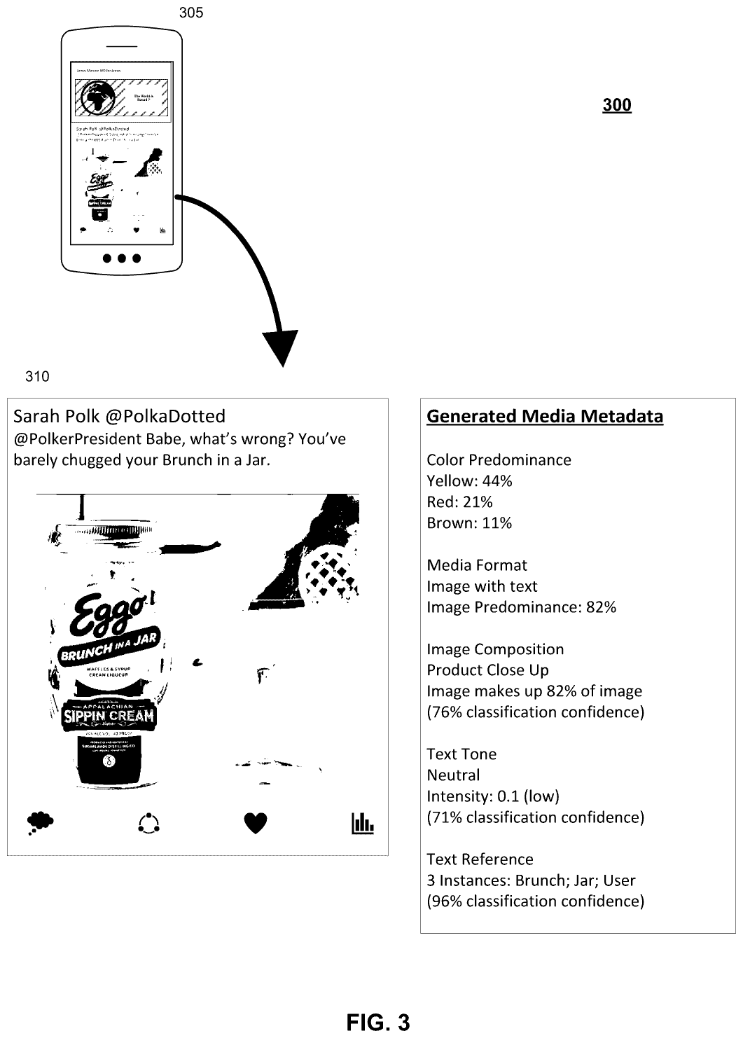

FIG. 3 illustrates an exemplary approach to calculating predominance that includes generating metadata associated with a media item or content item, in accordance with various embodiments of the present disclosure. As illustrated, user equipment 305 includes a display screen on which various media items are displayed thereon. Media 310, as illustrated, is a media post containing an image and text. In the photo, a “Brunch in a Jar” is displayed. Although FIG. 3 is illustrated monochromatically (i.e., black and white image) for simplicity, the techniques are illustrated for the color image, i.e., containing color.

Some features of the present disclosure may be associated with a particular approach (e.g., predefined) for calculating predominance. When analyzing dominant colors for example, the percentage of image occupied by a particular dominant color may be an effective predominance measure. As illustrated, system 300 analyzes the image of media 310 to determine the dominant colors displayed therein. System 300 determines that the image contains 44% yellow, 21% red, and 11% brown. Additionally, system 300 determines that media 310 is a product close up image of a product that contains text, the image exhibiting 82% predominance with a 76% classification confidence.

In addition to the color of the image, system 300 may, in some embodiments, also analyze other characteristics of media 310. For example, where media 310 includes text, system 300 may analyze the text to determine the sentiment of the text. As illustrated, media 310 includes text that reads, “Babe, what's wrong? You've barely chugged your Brunch in a Jar.” System 300 analyzes the language of media 310 to determine that the text exhibits a low intensity (with a score of 0.1) with a classification confidence of 71%. Any type of language analyzation technique(s), including NLP and ML based models, may be implemented without departing from the contemplated embodiments. For example, a bidirectional encoder representations from transformers (or BERT) model may be applied including its variants (e.g., ROBERTa, DistilBERT, ALBERT, ELECTRA, SpanBERT, and TinyBERT). Other applicable methods include, without limitation, lexicons, stemming, tokenization, speech tagging, context mining, embedding, annotation, polarity/subject classification. Moreover, commercially and/or publicly available language models may be used, for example, a generative pre-trained transformer or GPT (e.g., ChatGPT). Additionally, system 300 determines that the text includes three references: Brunch, Jar, and a user (@PolkerPresident). Although text tone and text references are illustrated and described with respect to FIG. 3, any features of text and/or images displayed in media 310 may be analyzed, without departing from the contemplated embodiments.

In other embodiments, system 300 analyzes other aspects of media 310. For example, system 300 may determine which areas of media 310 are in focus and, conversely, what areas are out of focus. In such an embodiment, system 300 weighs the various portions of media 310 according to whether they are in focus. For example, system 300 may apply a higher weight.

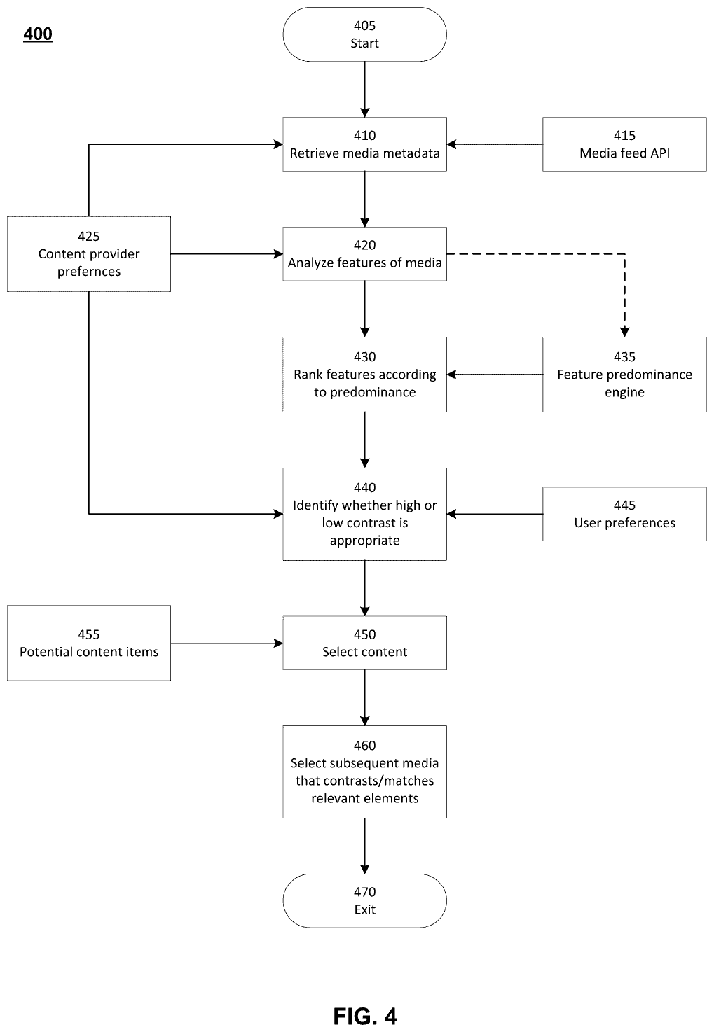

FIG. 4 illustrates an exemplary process for selecting multimedia content based on contrast, according to various embodiments of the present disclosure. At 405, process 400 starts. In some embodiments, process 400 is initialized on command, for example, by receiving a signal to begin implementing process 400. In other embodiments, process 400 is initialized for all content displayed. In other embodiments, system 400 initializes in response to an event. For example, system 400 is initialized every time a content item is needed to place in a content slot.

At 410, process 400 retrieves metadata related to media. In some embodiments, system 400 access such information from Media Feed API 415. Media Feed API 415 provides information related to the media, for example, information related to posts, user profiles, comments, or messages. For example, in an embodiment implemented with a social media feed, metadata may be retrieved from Media Feed API 415. Alternatively or in addition to retrieving information from media feed API 415, process 400 may retrieve media metadata from content provider 425 (discussed herein).

At 420, process 400 analyzes features of media. In some embodiments, the media analyzed includes, for example, media that includes a particular number of images, images from a specific timeframe, media that includes a particular number of words/characters, what is currently displayed on the user equipment, or what is selected to be displayed on user equipment, or any combination thereof. In some embodiments, media that is not displayed or only partially displayed on user equipment may be considered and weighted differently than media that is completely displayed on user equipment. In such an embodiment for example, if a media item is partially displayed (e.g., only a portion of the media item is visible), it may be weighted less than other media items that are displayed in their entirety. In this way, process 400 applies more weight to media items that may be of higher interest to the user.

In some embodiments, process 400 identifies missing features. For example, process 400 may apply sentiment analysis or dominant color extraction (e.g., as discussed with respect to FIG. 3) to determine such missing features.

At 425, process 400 retrieves information including content provider preferences. Content provider preferences 425 may include information that determines which metadata features are retrieved. In an embodiment, such information may be used at, e.g., 420. In such an embodiment, media to be analyzed may include a prespecified number of images, images from a pre-determined timeframe, or may be limited to what is currently displayed on the user equipment. In such an embodiment, content that is not partly visible on the user equipment (e.g., cut off from view) may be weighted based on how much content is visible or not visible, i.e., media that is only partially displayed on user equipment will be given a lower weight. After retrieving available metadata, any missing features may be set to a default or neutral value, or identified using, for example, existing techniques (e.g., sentiment analysis, dominant color extraction, etc.).

At 430, process 400 ranks features according to predominance. In some embodiments, process 400 applies various techniques for determining feature predominance of the detected features. In such an embodiment, process 400 implements, at 435, feature predominance engine in determining feature predominance. In such embodiments and considering an example analyzing an image, process 400 determines the most dominant colors in the image. In such an example, process 400 determines, e.g., the percentage of the image that is occupied by certain colors. In this way, system 400 determines which colors predominate the image and thereby is able to compare those colors against potential content to achieve a high or low contrast (discussed in more detail with respect to 440, 450).

In another example, process 400 may consider the sentiment of the media item in analyzing its features. In such an example, process 400 may determine the sentiment intensity of the media item in determining the feature predominance of the media item. For example, process 400 may analyze the media item to determine whether it contains a positive, neutral, or negative sentiment. In similar embodiments, process 400 may determine the sentiment more granularly. Instead of or in addition to a three-part positive, neutral, or negative determination, process 400 may determine whether the media item express emotional sentiment (e.g., happiness, sadness, anger, disappointment, etc.), interest (e.g., interested, disinterest), sarcasm, irony, and others.

In another example, where the media item contains words (either written or spoken), process 400 may determine the number of words or characters in the media item. In such examples, process 400 considers the number of words or characters appearing in an image or each frame of a video clip, and the total count of words or characters displayed during a unit of time (e.g., 3 seconds). In an example with a video, process 400 may consider the average or normalized count in a unit of time. The count of words may be replaced or combined with the area where the text appears or covers. Text may be presented in different font styles and sizes, and thus altogether take up different space and positioning. In some embodiments, he addition or insertion of words and text can be adjusted to represent a desired predominance score.

In some embodiments, process 400 accounts for features that do not have an associated predominance calculation approach. In such instances, process 400 may consider the features to have average predominance score, or alternatively, they may not be associated with any predominance score. Predominance scores, which may be represented by vectors of varying dimensions for various features, may be already associated with an approach to standardize values or a range of values to enable standardization using some methods (e.g., Z scores) to enable comparisons between features with different scales.

In some embodiments, the detected features may be omitted or otherwise removed from consideration. In such embodiments, the detected features may be “trimmed” to eliminate features with predominance scores below a threshold value to focus on those favored by content providers.

At 440, process 400 determines whether high or low contrast is appropriate. In some embodiments, process 400 considers user preferences in identifying whether high or low contrast content is appropriate. In such embodiments, at 445, process 400 retrieves user preference information. In such embodiments, user preferences may be detected from clickstream data or manually indicated by user preferences. For example, when a content item is inserted after a post containing a cat and the content provider indicated high content contrast, the content item would not contain a cat. If, however, the user loves cats (as determined by, e.g., user input or user history information), the process 400 may adjust the desired content contrast to match user preferences. In another example, the user may have strong preference for content with a sarcastic tone. In such an example, even if content providers desire high-contrast content, the appropriate content could keep the user-preferred sarcastic tone while incorporating high contrast into less preferred features.

At 450, process 400 selects the content. In some embodiments, process 400 selects content based on the identification of whether high or low contrast is appropriate, for example, as discussed with respect to 440. Process 400 identifies potential content items that best fit the determined appropriate contrast for each feature. Content providers may provide alternate versions of content items or content items with adjustable features.

In some embodiments, process 400 identifies potential content items with adjustable values and systematically adjusts the values to identify which combination of values produces the optimal contrast across features. In some embodiments, the results may be weighted by content provider and user preferences. For example, in an embodiment where color intensity is an adjustable feature, process 400 selects the highest and lowest values (e.g., 0 and 100) in a pre-approved range and select, e.g., N-2 number of evenly spaced intervals between them (e.g., N=5 would mean values of 0, 25, 50, 75, and 100). The value of N may be manually indicated by the user, provided by process 400, predetermined, dynamically adjusted, or limited by device or bandwidth constraints. Adjustable feature values may also be selected. For example, a content provider may indicate what color saturation may only be set to (e.g., black and white, full color, and 25% color). In such an example, process 400 maintains certain values of adjustable features constant while adjusting all other adjustable feature values.

In some embodiments, content providers may indicate whether selected content is to be similar to (e.g., exhibit low contrast) or different from (e.g., exhibit high contrast) features of the media items. Content providers may also indicate conditional match/contrast based on other features. For example, if a potential content item exhibits low color contrast as compared to surrounding media items, the content provider may indicate content items having high content contrast. In an example, if the content item contains a cat and is displayed near media items containing cats, the content provider may indicate to ensure low content contrast content items (e.g., content item containing cats) to increase the likelihood of appealing to the user. In some embodiments, the content provider may further indicate that displayed content items may contain cats but only if the color contrast is sufficiently high (i.e., having low content contrast while having a high color contrast).

In some embodiments, process 400 displays the selected content item at, for example, a user equipment device or multiple equipment devices. In other embodiments, process 400 provides the selected content item to another process or system. For example, process 400 may provide the selected content item to, e.g., a social media service that, in turn, displays the selected content at one or more user devices associated with that social media service.

The following describes an example mathematical formulation and corresponding solution for the techniques of the present disclosure. A feature matrix may be used to represent a given a piece of media or content. Each column vector of such a feature matrix represents quantitative measurements of specific features (e.g., color dominance, sentiment intensity, object recognition, etc.). With such a representation, constrained optimization techniques may be applied to identify content from a set of content items, such that the identified content item maximizes or minimizes contrast with one or more pieces of surrounding media items. In some embodiments, the content may be subject to a set of constraints such as user preferences, contextual relevance, and platform guidelines.

### Feature Extraction and Representation

Feature extraction represents content as numerical features that can be processed while still accurately describing the content. In the context of content analysis, this involves converting different types of content/media (e.g., images, text, video, audio) into a feature matrix where each column represents a quantifiable aspect of the content/media. Certain techniques can be used for feature extraction as discussed herein.

Regarding text, for example, a Bag of Words Model may be implemented that represents text by the frequency of each word or phrase. In another example, Term Frequency-Inverse Document Frequency (TF-IDF) may be implemented that weighs the frequency of each word by its inverse frequency in the corpus to reflect the importance of a word in the context of a content item, media item, or document. In another example, word embeddings (e.g., Word2Vec) may be implemented to convert words into vectors, and also using transformer models such as BERT or GPT to create context-aware embeddings for words and sentences. Although certain word embeddings and transformer models may be illustrated and described, any type of word modeling may be implemented without departing from the contemplated embodiments.

Regarding images, for example, color histograms may be implemented to quantify the distribution of colors in an image. In another example, deep convolutional neural networks (CNN) may be implemented to automatically learn a feature vector. In another examples, a pre-trained models to extract feature vectors from images may be implemented.

Regarding video, for example, frame-by-frame analysis and motion analysis may be implemented to identify features from individual frames and motion between frames. 3D CNNs or Recurrent Neural networks (RNNs) may be implemented to capture both the temporal and spatial features of a video sequence.

Regarding audio, for example, spectral features like spectrogram or MFCC (Mel-Frequency Cepstral Coefficients) may be implemented to represent audio sequences, as well as the pre-trained audio models trained on large audio datasets to derive feature vectors representing audio sequences.

Different features with different lengths based on the models or algorithms utilized may be implemented to extract certain features. For example, feature engineering may also be implemented to standardize features (e.g., features of media or content items) into the same length so that a feature matrix can be implemented for each piece of media/content. A deep learning multi-modality model may be implemented to represent each piece of media/content as a feature matrix, similar to CLIP models developed for text and image input. Implementing a feature matrix enables a representation for media/content with each type of feature. At the end of feature extraction stage, for a single content item C, matrix Mc is determined where each column corresponds to a feature type vector:

M_{C}=[v₁, v₂, v₃, . . . , vₖ]

where:
vᵢ is the vector representation of the i^{th} feature type for media/content C
k is the total number of feature types

### Calculating Contrast Between Content Items

For a system designed to evaluate contrast between media/content for advertising purposes, the choice of metric depends on how contrast is defined and the nature of the features. As used herein, “contrast” should be understood to mean the differences among certain features, aspects, graphics, words, elements, etc. For example, “contrast” should be understood to describe features of an image, e.g., color saturation, color tone, or luminosity. “Contrast” should also be understood to describe the relative relationship between elements of an image, e.g., cat versus dog, animal versus plant, person versus pet. “Contrast” should further be understood to describe sentiment, e.g., sarcastic versus serious, upbeat versus solemn, happy versus sad. “Contrast” should also be understood to describe relative formatting, e.g., text versus image versus audio versus video. “Contrast” should also be understood to describe relative composition, e.g., close-up versus landscape. That is, “contrast” should not be understood to be limited to traditional image processing and, instead, should be understood relate to describing the relative differences (whether high or low) of any aspect of any media or content item discussed herein.

Since each type of feature is represented as a vector, contrast in that type of feature space is measured. Mathematically calculating contrast is equivalent to calculating the distance of two feature vectors, where a large distance is indicative of high contrast and a small distance indicative of low contrast. In an implementation, cosine distance may be used to measure the similarity between two feature vectors. There are some alternatives to consider, including Euclidean distance, Manhattan distance, Mahalanobis distance, correlation coefficient, Jaccard index, KL divergence or relative entropy, and Hamming distance.

In some embodiments, multiple distance measures are combined for a more robust contrast evaluation. For example, cosine distance may be used for textual features where orientation matters more than magnitude, while Euclidean distance may be used for audio or visual features where the magnitude of features is important.

When considering multiple types of features, calculating contrast requires a method that can account for the different natures and scales of such features. A composite measure is needed that combines the individual contrasts into a single contrast score. In an embodiment, the features may be normalized to ensure that all feature measurements are on a comparable scale, weights may be assigned to each feature based on their importance or relevance, and individual contrasts aggregated into a unified contrast score as:

$$Contrast Score = {\sum }_{i = 1}^{n} {w}_{i} \cdot {Contrast}_{i}$$

where:
wᵢ is the weight of the i^{th} feature
Contrastᵢ is the contrast function for the i^{th} feature

### Constrained Optimization

The above combined contrast score can be used for the general case when a content provider (e.g., an advertiser) desires to insert a high- or low-contrast content item (e.g., advertisement). Content providers can adjust the weights to focus more on some types of features. While other factors may be considered (e.g., user preferences), content provider goals and user preferences may be balanced, and an optimization model that aims to maximize or minimize the contrast for certain features while considering user preferences as constraints may be implemented. Mathematically, such optimization seeks to find content B* that maximizes or minimizes contrast for a set of features F when compared to a reference content A (e.g., content item or media item), as desired by the content provider. In an embodiment, if there is a sequence of history content Aᵢ, the weight average A may be used to represent the sequence of content, in some embodiments, with high weights assigned to more recent content in the sequence, particularly for displayed media/content. The discussed optimization model can be formulated as follows:

$${B}^{*} = arg {max}_{B} {\sum }_{i = 1}^{n} {w}_{i} \cdot {Contrast}_{i} ( A , B )$$

$$or$$

$${B}^{*} = arg {min}_{B} {\sum }_{i = 1}^{n} {w}_{i} \cdot {Contrast}_{i} ( A , B )$$

where:
Contrastᵢ (A,B) is the contrast function for the i^{th} feature between content A (e.g., media or content item) and candidate content B (e.g., media or content item)
wᵢ is the weight representing the importance of the i^{th} feature as specified by the content provider
n is the total number of features considered
   If the solution needs to respect user preferences, which could be represented as a series of constraints C:
Cⱼ(B)≤User Preference Thresholdⱼ (for maximization problems)
Cⱼ(B)≥User Preference Thresholdⱼ (for minimization problems)
   where:
Cⱼ(B) are the constraint functions representing the measurements of feature j in content B
User Preference Thresholdⱼ is the user-defined threshold for feature j
   For example, if the user prefers a consistent sarcastic tone, while the advertiser indicates to maximize contrast, the sarcastic tone may be represented using a textual feature vector fₛ and the constraint may be expressed as:

$${C}_{j} ( B ) = {Contrast}_{j} ( {B}_{j} , {f}_{s} ) \leq Th$$

where:
Bⱼ is the text feature of content B
This the threshold, which could be a small value so that the content B maintains a sarcastic tone

In general, user preferences impose constraints on modeling optimization. In some embodiments, user preferences are integrated directly into the optimization as hard constraints or, in other embodiments, as penalty terms in the objective function for soft constraints.

Many optimization techniques based on the nature of the objective function and constraints can be applied. For example, Linear Programming (LP) may be used for linear objective functions and constraints, and Non-Linear Programming (NLP) for non-linear objective functions and/or constraints. In some embodiments, heuristic algorithms for complex or non-differentiable landscapes, such as Genetic Algorithms or Simulated Annealing may be used.

In another embodiment, content providers (e.g., advertisers) may supply content items (e.g., advertisements) that enable modifying identified features in a discrete (i.e., different versions) or continuous (i.e., adjustable variables) manner, for example, based on user preferences, content provider preferences, or context. In such an embodiment, a content item with a text joke may contain multiple versions of the joke with different tones/comedic styles. In a continuous embodiment, the content provider may indicate that color intensity or saturation may be adjusted to ensure more effective contrast.

In another embodiment, contrast may be established between potential content and the real-world environment. Certain techniques for computer vision such as semantic segmentation may be applied to identify nearby objects that may influence perceived contrast. For example, an AR system may attempt to place a content item (e.g., advertisement) on a user's wall or other object. If the wall is predominantly or completely white, colorful content may be depicted on the wall or other object to ensure contrasting content. In another example where the user's wall displays records in square frames, a similarly sized square content item (e.g., advertisement) that matches the color and contrast of the records may be depicted on the wall. Content providers may indicate alternate contrast preferences for digital and analog content item (e.g., advertising) placement, which may include novel features that are not relevant to digital advertising (e.g., shape, spacing, etc.).

In another embodiment, whether a particular content item (e.g., advertisement) includes low contrast or high contrast, rather than being a set parameter by the content provider (e.g., advertising campaign manager), can be automated. Media and content (text, audio, or visual content) can be analyzed to determine whether the words, audio or visual content expressing high intensity or low intensity. For text, such analysis may include NLP process to determine whether the words/expressions used in the text are common words or uncommon (e.g., “rare”) words, or whether the elements in the media/content (e.g., words) include any emotionally charged context/sentiment to attract attention. Similarly, audio media/content can be analyzed if high pitch, tone, or volume is included in the audio media/content (e.g., music, voice, etc.). Video media/content can be analyzed to determine whether it includes fast motion (by for example, reviewing the key frames, GOP structure) camera angle changes. If the analysis concludes that the media item exhibits a predominance higher than a normal threshold, a content item exhibiting high contrast may be selected. Conversely, if the analysis concludes that the media item exhibits a predominance lower than a threshold, a content item exhibiting low contrast may be selected. In such an example, it may be more appropriate to blend the content item (e.g., advertisement) with the surrounding media among which the content item appears so as to not appear as an advertisement.

At 460, process 400 selects subsequent media. Once the content item has been selected, process 400 selects subsequent media items to ensure a desired or preferred contrast on relevant features. The identified features with corresponding predominance values of preceding media items may be used to guide selection of subsequent media. The amount of contrast to the preceding media items may vary within a range and may increase or decrease (e.g., over time, over a range of media items), which can be set by a user, the content provider, the media provider, process 400, or any combination thereof. For example, a user may specify to selection of high contrast media every 10 minutes or every 10 media items, with low content contrast being presented otherwise.

In some embodiments, process 400 selects subsequent content based solely on information received from media provider (i.e., subsequent media content is displayed without any modification to selection criteria apart from those specified by the media provider). In such embodiments, process 400 selects and displays media items as they would otherwise be displayed. In other embodiments, process 400 selects subsequent media based on certain criteria. For example, process 400 may select subsequent media to achieve a particular contrast (either high or low) with respect to displayed media or content, e.g., the content selected at 450. Selecting subsequent media to achieve a particular contrast allows process 400 to present particular content items even if it would not otherwise match contrast criteria. For example, where a content provider has indicated that a particular content item is to be displayed but that content item does not meet contrast criteria (e.g., relative to preceding media items), process 400 may select certain media items to be displayed so that the specified content item would then match the contrast criteria. In this way, process 400 can select and display any content item while meeting a specified contrast criteria for any number of parameters.

At 470, process 400 exits. In some embodiments, process 400 exits automatically. In other embodiments, process 400 exits in response to an input. For example, process 400 may exit in response to receiving an indication from a media provider, a content provider, a third party, or any combination thereof.

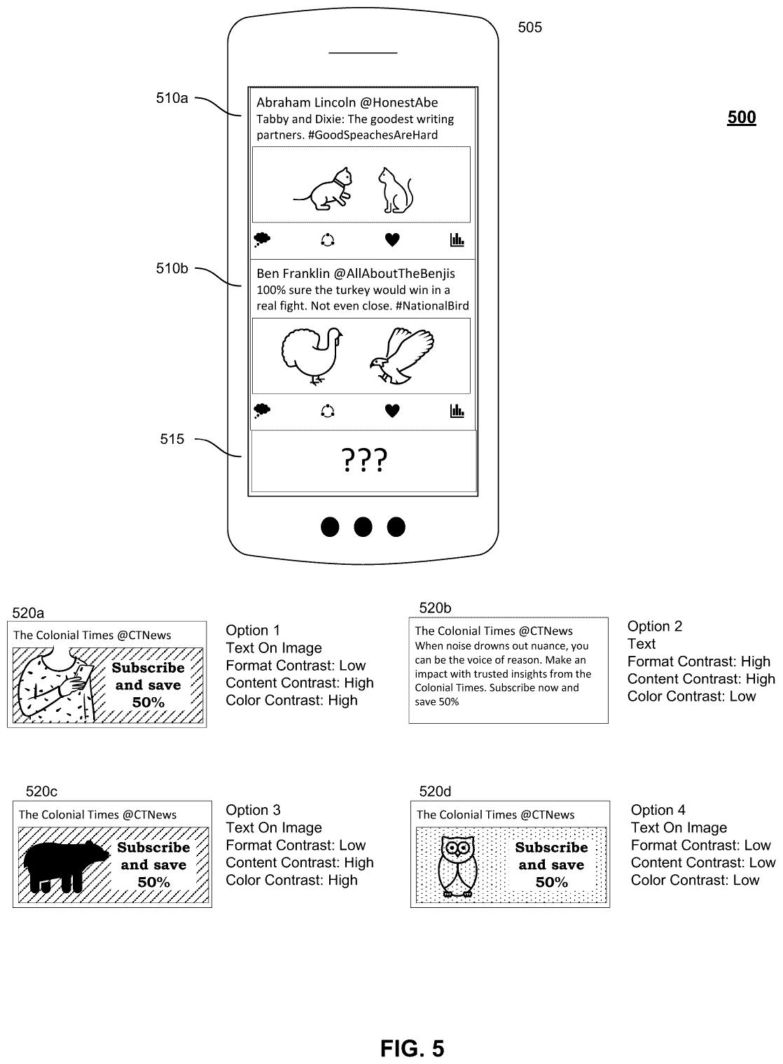

In another example embodiment of the present disclosure and with reference to FIG. 5, system 500 selects a content item to display. System 500 includes user equipment device 505 with media items 510a, 510b displayed thereon. As illustrated, media item 510a is embodied by a social media post that includes text and an image of cats. Media item 510b is embodied by a social media post that includes text an image of birds with a background color that is similar to media item 510a. In the illustrated embodiment, system 500 considers four content items to display at content item slot 515.

In the illustrated embodiment, content item 520a includes text and an image of a person having a background color (as illustrated with a crosshatch pattern) that is different than media items 510a, 510b. Content item 520b includes text with a background color that is similar to media items 510a, 510b. Content item 520c includes text and an image of a bear with a background color (as illustrated with a crosshatch pattern) that is different than media items 510a, 510b but is similar to content item 520a. Content item 520d includes text and an image of an owl with a background color that is similar to media items 510a, 510b.

As illustrated, user equipment displays media items 510a, 510b and determines which of the content items 520a, 520b, 520c, 520d to display at content item slot 515. System 500 considers content provider preferences (e.g., those discussed with respect to 425) to determine which content item to display.

For example, if the content provider preferences indicate that a content item having low format contrast while having high content and color contrast is to be selected, system 500 selects Option 1—content item 520a. Content item 520a exhibits low format contrast as compared to media items 510a, 510b (all including an image and text); high content contrast (image of a person versus images of animals); and high color contrast.

In another example, if the content provider preferences indicate that a content item having low color contrast while having high format and content contrast is to be selected, system 500 selects Option 2—content item 520b. Content item 520b exhibits high format contrast as compared to media items 510a, 510b (media items 510a, 510b have images and text while content item 520b only contains text); high content contrast (images of animals versus text or no images at all); and low color contrast (all three have light colored backgrounds).

In another example, if the content provider preferences indicate that a content item having low format contrast while having high color and content contrast is to be selected, system 500 selects Option 3—content item 520c. Content item 520c exhibits low format contrast as compared to media items 510a, 510b (all three contain images of animals); high content contrast (images of cats and birds versus an image of a bear); and high color contrast.

In another example, if the content provider preferences indicate that a content item having low format, color, and content contrast is to be selected, system 500 selects Option 4—content item 520d. Content item 520d exhibits low format contrast as compared to media items 510a, 510b (media item 510b and content item 520d both contain images of birds); low content contrast (all three include images and text); and low color contrast (all three having light colored backgrounds).

Although three parameters are discussed with respect to system 500's selection (format, content, and color), system 500 may consider more and/or other parameters, without departing from the contemplated embodiments. For example, system 500 may consider tone, composition, sentiment, etc., in addition to or in leu of one or more of the format, content, and color.

Additionally, system 500 may consider one or more of the parameters with a higher or lower level of abstractions, granularity, or specificity, without departing from the contemplated embodiments. For example, system 500 may consider the type of animal that is displayed in the images presented in the content items. In such an example, system 500 may consider content item 520c to have a low content contrast as compared to media item 510a because both contain animals, or because both contain mammals, or because both contain four-legged animals, or because both contain four-legged mammals with tails.

Alternatively, system 500 may consider media item 510a to have a high content contrast as compared to content item 520c. For example, system 500 may consider content item 520c to have a high content contrast as compared to media item 510a because media item 510a includes an image of a cat while content item 520c includes an image of a bear, or because media item 510a contains an image of two animals while content item 520c contains an image of a single animal, or because media item 510a includes an image of a small animal while content item 520c includes an image of a large animal, or because media item 510a includes an image of a domesticated animal while content item 520c includes an image of a wild animal, etc. Although certain parameters are discussed at certain levels of abstraction, granularity, specificity, etc., any number of parameters may be considered at any level of abstractions, granularity, and/or specificity without departing from the contemplated embodiments.

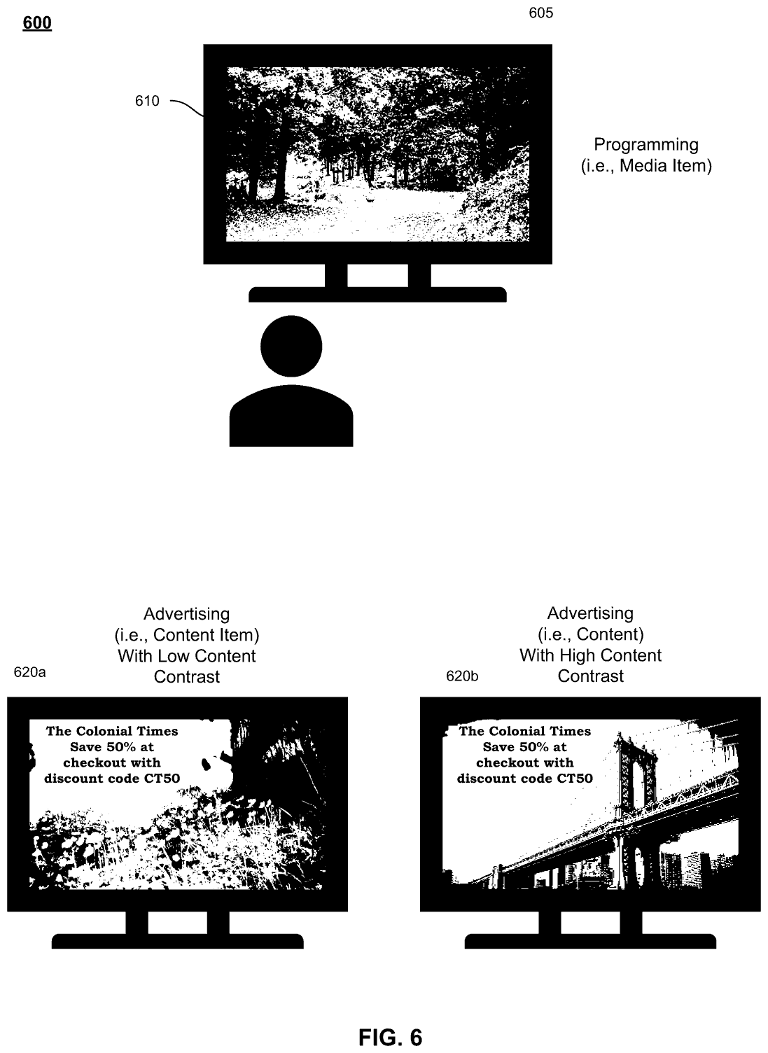

In another exemplary embodiment of the present disclosure and with reference to FIG. 6, system 600 includes user equipment 605 having media item 610 displayed thereon. As illustrated, user equipment 605 is embodied by a television and media item 610 is embodied television programming displaying a countryscape scene. System 600 determines whether to select a high contrast or a low contrast content item to display in the next content item slot (e.g., advertising break). Content item 620a contains low content contrast because, like media item 610, it includes countryscape scenery while content item 620b contains high content contrast because it contains cityscape scenery.

Although user equipment 605 is illustrated and described as a television displaying media programming, user equipment 605 may be any type of user device without departing from the contemplated embodiments. For example, user equipment 605 may be embodied by a computer, projector, tablet, or any other device with which media is consumed. Moreover, user equipment 605 may be embodied by wearable technology devices, without departing from the contemplated embodiments. For example, user equipment 605 may be embodied by a smartwatch, virtual reality goggles, augmented reality goggles, headphones, or earbuds without departing from the contemplated embodiments.

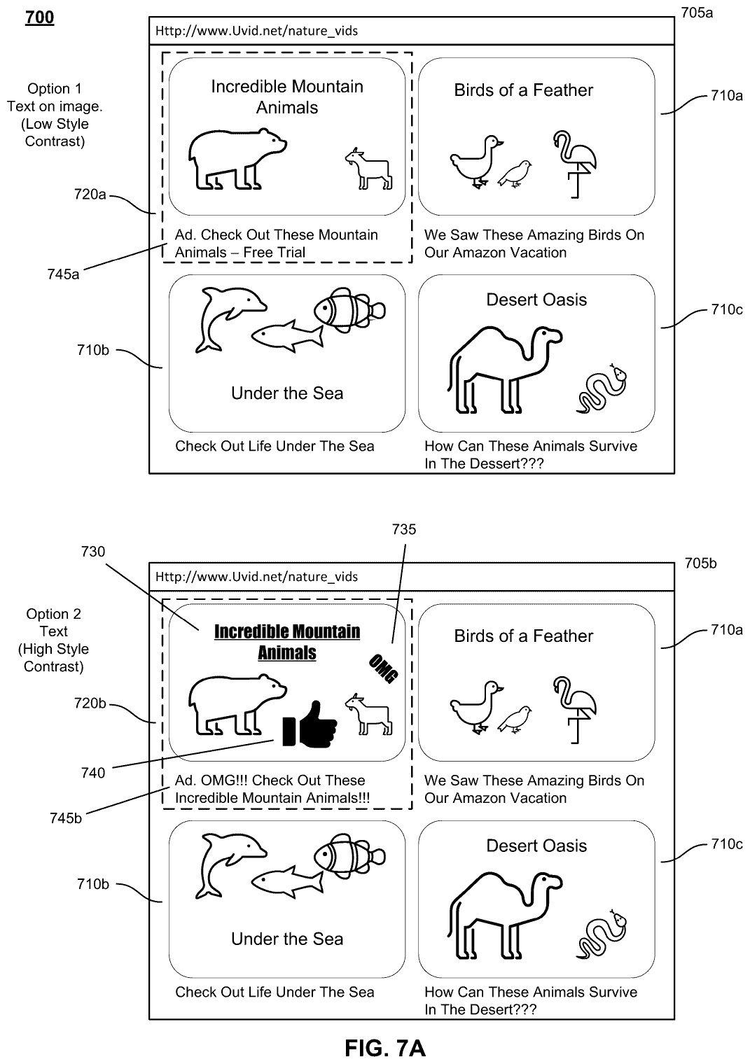

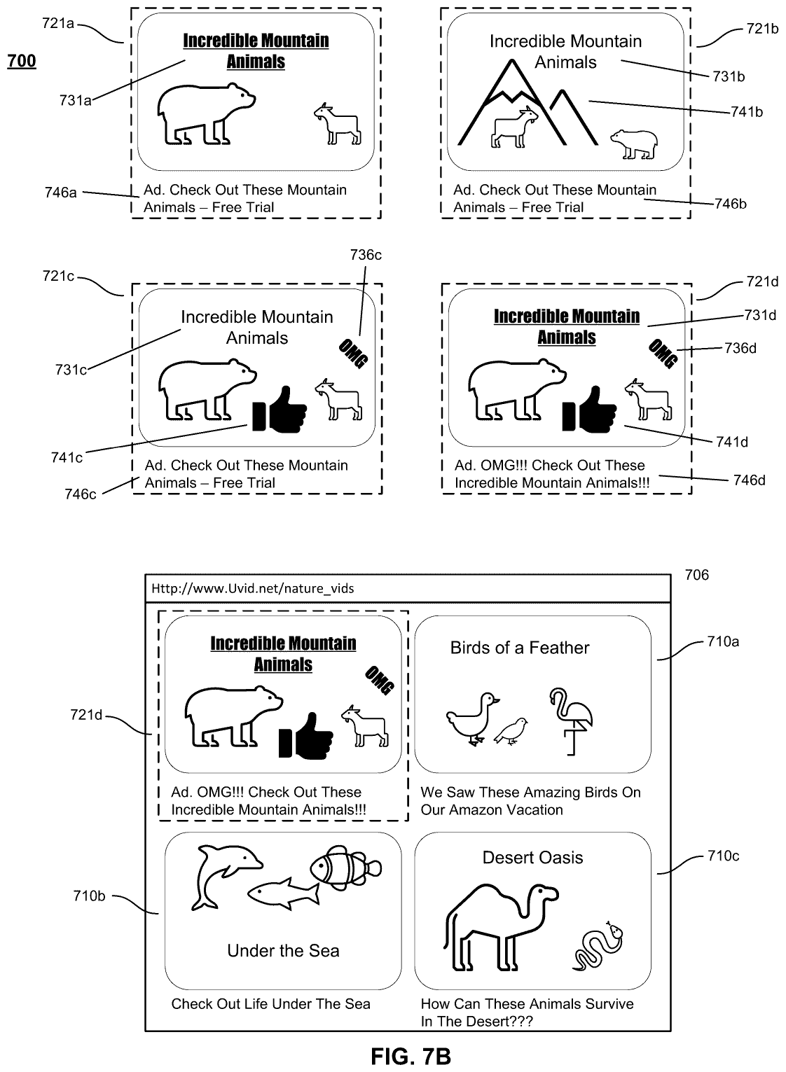

In another exemplary embodiment of the present disclosure and with reference to FIGS. 7A and 7B, system 700 includes user equipment 705a and 705b. As illustrated, user equipment 705a is embodied by a web-based multimedia sharing platform and includes media items 710a, 710b, and 710c, and content item 720a. In some embodiments, example web-based multimedia sharing platforms embodied by user equipment 705a include, for example, YouTube, Vimeo, Dailymotion, Facebook Watch, Twitch, TikTok, Instagram, Netflix, Amazon, etc.

As illustrated in FIG. 7, content item 720a is embodied by an advertisement displayed among thumbnails related to various videos. System 700 determines whether content item 720a it so be modified based on various parameters, e.g., exhibiting high or low contrast as compared to media items (as discussed herein). As displayed on user equipment 705a, content item 720a (i.e., Option 1) exhibits low style, content, format, and composition contrast as compared to media items 710a, 710b, and 710c in that it shares similar tone, font, imagery, and overall aesthetic as media items 710a, 710b, and 710c. Such a configuration is optimal where, for example, content provider preferences indicate a low contrast is to be selected.

In contrast and as displayed on user equipment 705b, content item 720b (i.e., Option 2) exhibits a high style, content, format, and composition contrast as compared to media items 710a, 710b, and 710c in that the font, while containing the same text, is contrastingly different than that of content item 720a. Text 730 exhibits a different font that is underlined and emboldened, as compared to the corresponding text of content item 720a. Additionally, content item 720b includes text element 735 and graphic element 740 that do not have corresponding elements in content item 720a, which further contrast content item 720b as compared to media items 710a, 710b, and 710c. Also, text 745b contrasts that of text 745a, as illustrated, text 745b includes “OMG!!!.” Although only two options are illustrated and described with respect to content items 720a and 720b, system 700 may include any number of options for contrasting content items without departing from the contemplated embodiments.

FIG. 7B illustrates an embodiment of the present disclosure where system 700 includes more than two options for a content item to achieve a particular contrast. As illustrated, system 700 includes four options—content items 721a, 721b, 721c, and 721d. As compared to content item 720a, content item 721a includes text 731a that is emboldened and underlined, while text 746a and the images displayed in content item 721a are similar to that of content item 720a.

As compared to content item 720a, content item 721b includes graphic element 741b (e.g., mountain scenery) and the images, while depicting the same animals, are different in relative size and orientation. Text 731b and text 746b are similar to those displayed in content item 730a. Content item 721c includes graphic element 741c and text element 736c that do not have corresponding counterparts in content item 720a, while text 746c is similar to that of content item 720a. Content item 721d contains various contrasting elements, as discussed with respect to FIG. 7A.

Content items 721a, 721b, 721c, 721d represent four discrete iterations of content item 720a, from which system 700 may select to display among media items 710a, 710b, 710c based on indicated contrast preferences. In some embodiments, content items 721a, 721b, 721c, 721d are predetermined and system 700 selects the specific content item to display.

In other embodiments, system 700 dynamically adjusts the various elements of a content item in determining and selecting a content item to display (for example, as discussed with respect to 450, 455, 460 of FIG. 4). In such embodiments, text 746a, 446b, 746c, 746d; text 731a, 731b, 731c, 731d; graphic element 741b, 741c, 741d; and text element 736c, 736d each represent various elements that system 700 dynamically adjusts in determining and selecting a content item to display.

For example, where high text contrast is indicated, system 700 may dynamically adjust the text of content item 720a to include text 746d, text 731a, and/or text elements 736c, 736d because such elements are not displayed in media items 710a, 710b, 710c. In another example, where high content contrast is indicated, system 700 may dynamically adjust the content of content item to include graphic element 741b, 741c and/or text element 736c, 736d because such elements are not displayed in media items 710a, 710b, 710c. Although system 700 is illustrated and described as dynamically adjusting certain graphic and text elements, system 700 may adjust (dynamically or otherwise) any number of graphic or text elements containing any amount of high contrast or low contrast elements, without departing from the contemplated embodiments.

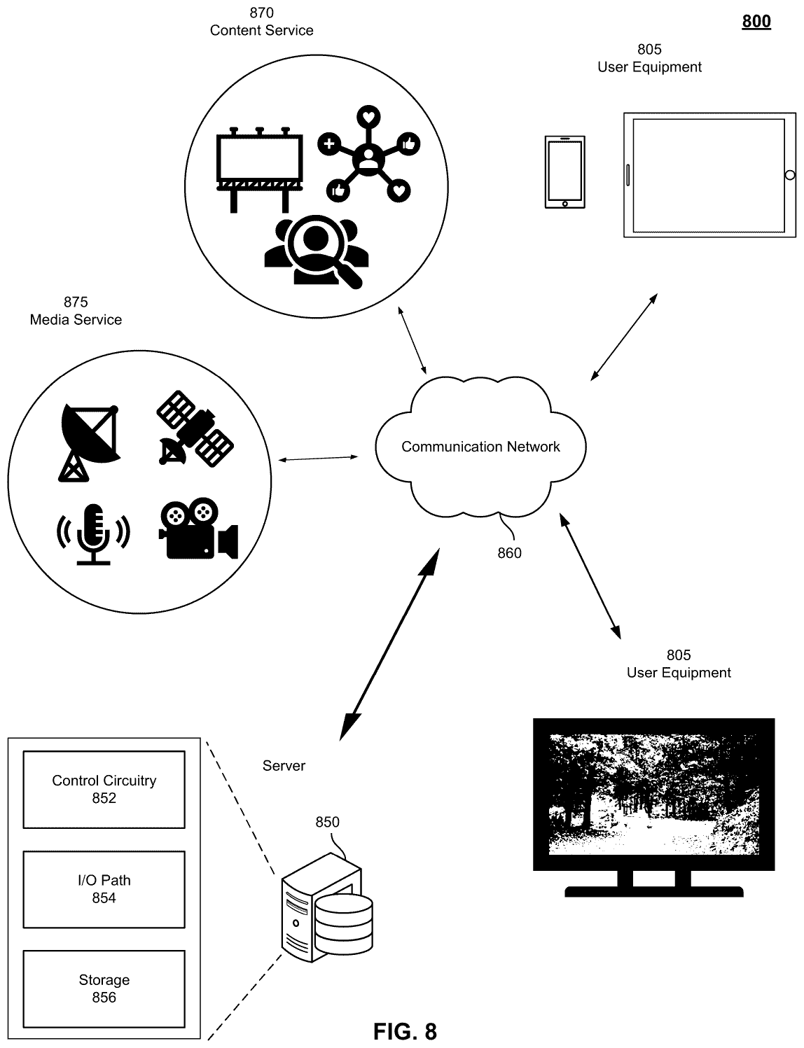

In another example embodiment of the present disclosure and with reference to FIG. 8, System 800 includes user equipment 805, content service 870, media service 875, server 850, which communicate with one another using communication network 860. In some embodiments, server 850 includes control circuitry 852, I/O path 854, and storage 856. FIG. 8 illustrates generalized embodiments of an illustrative user equipment 805, e.g., user equipment 105, 205, 305, 505, 605, 705, 706. For example, user equipment 805 may be a television, smartphone device, a tablet, or a computer, such as illustrative user equipment 805. In other embodiments, user equipment 805 is embodied by AR/VR goggles, smart watches, and user interfaces displayed on display devices (e.g., web pages, apps, programs, etc.). In some embodiments, server 850 may include one or more circuit boards. In some embodiments, the circuit boards may include control circuitry (e.g., control circuitry 852) and storage (e.g., RAM, ROM, Hard Disk, Removable Disk, etc.) (e.g., storage 856). In some embodiments, circuit boards may include an input/output path (e.g., I/O Path 854). In some embodiments, user equipment 805 may receive content and data via input/output (“I/O”) path 854. I/O path 854 may provide content (e.g., content/media/preference data/information available over a local area network (LAN) or wide area network (WAN), and/or other content) and data to control circuitry 852 and storage 856. Control circuitry 852 may be used to send and receive commands, requests, and other suitable data using I/O path 854. I/O path 854 may connect control circuitry 852 to one or more communications paths (described herein). I/O functions may be provided by one or more of these communications paths but are shown as a single path in FIG. 8 to avoid overcomplicating the drawing.

Control circuitry 852 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate units, for example, multiple of the same type of processing units (e.g., two Intel Core i7 processors) or multiple different processors (e.g., an Intel Core i5 processor and an Intel Core i7 processor). In some embodiments, control circuitry 852 executes instructions for an application stored in memory (e.g., storage 856). Specifically, control circuitry 852 may be instructed by the application to perform the functions and techniques discussed herein. For example, the application may provide instructions to control circuitry 852 to analyze media items and determine which content item to select and display based on preferences or other information. In some embodiments, any action performed by control circuitry 852 may be based on instructions received from the application.

In client server-based embodiments, control circuitry 852 may include communications circuitry suitable for communicating with a user equipment (e.g., user equipment 805) or other networks or servers. The instructions for carrying out the functionality discussed herein may be stored on the server (e.g., server 850). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry (e.g., I/O Path 854). Such communications may involve the Internet or any other suitable communications networks or paths (e.g., I/O Path 854). In addition, communications circuitry may include circuitry that enables peer-to-peer communication of user equipment devices, or communication of user equipment devices in locations remote from each other (described in more detail herein).

Memory may be an electronic storage device provided as storage 856 that is part of control circuitry 852. As referred to herein, the phrase “electronic storage device” or “storage device” should be understood to mean any device for storing electronic data, computer software, or firmware, such as random-access memory, read-only memory, hard drives, non-transitory computer readable medium, or any other suitable fixed or removable storage devices, and/or any combination of the same. Storage 856 may be used to store various types of content, media data, and instructions for executing applications or instructions. Nonvolatile memory may also be used (e.g., to launch a boot-up routine and other instructions).

Storage 856 may additionally be used to implement certain features of the present disclosure. For example, content provider preferences 425, user preferences 445, and potential content items 755 (as discussed with respect to FIG. 4) may be stored at storage 856. In some embodiments, storage 856 is included one or more of the described user equipment devices. In another example, storage 856 may media or content information, as discussed with respect to FIGS. 1, 2, 3, 6, and 7. In another example, storage 856 may store historical information, as discussed with respect to FIGS. 1, 2, 3, 6, and 7.

Control circuitry 852 may include video-generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 852 may also include scaler circuitry for upconverting and downconverting content into the preferred output format of the user equipment 805. Circuitry 852 may also include digital-to-analog converter circuitry and analog-to-digital converter circuitry for converting between digital and analog signals. The tuning and encoding circuitry may also be used to receive navigation, guidance, and lane restriction data. The circuitry described herein, including for example, the tuning, video-generating, encoding, decoding, encrypting, decrypting, scaler, navigating, and analog/digital circuitry, may be implemented using software running on one or more general purpose or specialized processors. In embodiments where storage 856 is provided as a separate device from user equipment 805, the mapping and encoding circuitry may be associated with storage 856.

A user may send instructions to control circuitry 852 using a user input interface (e.g., at user equipment 105, 205, 305, 505, 605, 705, 706, 805). Such user input interface may be any suitable user interface, such as a remote control, mouse, trackball, keypad, keyboard, touchscreen, touchpad, stylus input, joystick, voice recognition interface, or other user input interfaces. The user interface may be provided as a stand-alone device or integrated with other elements of each one of user equipment 105, 205, 305, 505, 605, 705, 706, 805. For example, such user interfaces may be a touchscreen or touch-sensitive display. Additionally, content providers may send instructions to control circuitry 852 using, for example, the techniques discussed herein.

Content service 870 may be implemented using any suitable architecture. For example, content service 870 may be a stand-alone application wholly implemented on user equipment 105, 205, 305, 505, 605, 705, 706, 805. In such an approach, instructions for the application are stored locally, and data for use by the application is downloaded on a periodic basis (e.g., from an out-of-band feed, from an Internet resource, or using another suitable approach). Control circuitry at user equipment (e.g., 105, 205, 305, 505, 605, 705, 706, 805) retrieves instructions of the application from storage (e.g., storage 856) and process the instructions to generate any of the displays discussed herein. Based on the processed instructions, control circuitry may determine what action to perform when input is received from input interface.

Similarly, media service 875 may be implemented using any suitable architecture. For example, media service 875 may be a stand-alone application wholly implemented on user equipment 105, 205, 305, 505, 605, 705, 706, 805. In such an approach, instructions for the application are stored locally, and data for use by the application is downloaded on a periodic basis (e.g., from an out-of-band feed, from an Internet resource, or using another suitable approach). Control circuitry at user equipment (e.g., 105, 205, 305, 505, 605, 705, 706, 805) retrieves instructions of the application from storage (e.g., storage 856) and process the instructions to generate any of the content items discussed herein. Based on the processed instructions, control circuitry may determine what action to perform when input is received from such input interface or media service 875.

In an embodiment, user equipment 805 displays a media item and requests a content item to display after the currently displayed media item from content service 870 using communication network 860. In such an embodiment, user equipment 805 requests a content item and, in some embodiments, also provides content provider preferences. In an exemplary embodiment, user equipment 805 requests the content item from content service 870 using communication network 860. In such an embodiment, user equipment 805 requests the content item that meets certain contrast indications. User equipment 805 displays a user interface that displays various information, for example, the media item and/or the selected content item. Additionally, the user interface displayed on user equipment 805 also provides user selectable inputs that switch between media items and/or to input user preferences (e.g., whether the user prefers media/content items that include certain animals). In some embodiments, user equipment 805 communicates with content service 870 using communication network 860 to send and receive content information displayed on user equipment 805.

In another exemplary embodiment, user equipment 805 stores information. For example, user equipment 805 stores information related to media items, content items, content service preferences, or user preferences. Alternatively or in addition, some or all of the computational resources used by user equipment 805 are implemented at server 850. For example, information stored at user 805 can be stored at server 850, for example, at storage 856. Additionally, some are all of the methods or processes implemented by user equipment 805 are implemented at server 850, for example, at control circuitry 852. In such an embodiment, information can be communicated between server 850 and user equipment 805 over communication network 860 and using, for example, IO path 854. In some embodiments, content service 870 is implemented at server 850.

It is contemplated that some suitable steps or suitable descriptions of FIG. 5 may be used with other suitable embodiments of this disclosure. In addition, some suitable steps and descriptions described in relation to FIG. 5 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-4, 6-8 could be used to perform one or more of the steps in FIG. 5.

The processes discussed herein are intended to be illustrative and not limiting. For instance, the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
receiving, from a media provider, media information related to a plurality of media items for display at a user device;
determining, using control circuitry, for each media item of the plurality of media items and based on the received media information, a set of feature attributes;
receiving, from a content provider, a contrast indicator that relates to a feature attribute of the set of feature attributes;
selecting, using control circuitry, based on the set of feature attributes and the contrast indicator, a content item; and
displaying, at the user device, the selected content item and a media item of the plurality of media items.

2. The method of claim 1, wherein the feature attribute of the set of feature attributes relates to a modality selected from the group consisting of color, context, format, sentiment, tone, and composition.

3. The method of claim 1, wherein a feature attribute of the set of feature attributes relates to a color profile of the plurality of media items; wherein the received contrast indicator is associated with high contrast; and wherein the selected content item comprises a content color profile that is distinct from the color profile of the plurality of media items.

4. The method of claim 1, wherein a feature attribute of the set of feature attributes relates to a color profile of the plurality of media items; wherein the received contrast indicator is associated with low contrast; and wherein the selected content item comprises a content color profile that is similar to the color profile of the plurality of media items.

5. The method of claim 1 further comprising:
determining, for each feature attribute of the set of feature attributes, a predominance score; and
ranking the plurality of media items based on the determined predominance score.

6. The method of claim 1 further comprising retrieving, from a database, user preferences;
wherein selecting the content item is further based on the user preferences.

7. The method of claim 6, wherein the user preferences include historical user information associated with the user device.

8. The method of claim 1, wherein the step of determining the set of feature attributes further comprises:
determining, for each feature attribute of the set of feature attributes, a feature attribute score; and
ranking each feature attribute of the set of feature attributes according to the determined feature attribute score.

9. The method of claim 1 further comprising:
receiving, from the content provider, a second contrast indicator that relates to a second feature attribute of the set of feature attributes; and
wherein selecting the content item is further based on the second contrast indicator.

10. The method of claim 9, wherein the first contrast indicator and the second contrast indicator relate to different modalities of feature attributes.

11. A system comprising:
a memory configured to store media information and content information;
input/output circuitry configured to:
receive, from a media provider, media information related to a plurality of media items for display at a user device; and
receive, from a content provider, a contrast indicator that relates to a feature attribute of a set of feature attributes;
control circuitry configure to:
determine, for each media item of the plurality of media items and based on the received media information, the set of feature attributes;
select, based on the set of feature attributes and the contrast indicator, a content item; and
cause to be displayed, at the user device, the selected content item and a media item of the plurality of media items.

12. The system of claim 11, wherein the feature attribute of the set of feature attributes relates to a feature attribute modality selected from the group consisting of color, context, format, sentiment, tone, and composition.

13. The system of claim 11, wherein a feature attribute of the set of feature attributes relates to a color profile of the plurality of media items; wherein the received contrast indicator is associated with high contrast; and wherein the selected content item comprises a content color profile that is distinct from the color profile of the plurality of media items.

14. The system of claim 11, wherein a feature attribute of the set of feature attributes relates to a color profile of the plurality of media items; wherein the received contrast indicator is associated with low contrast; and wherein the selected content item comprises a content color profile that is similar to the color profile of the plurality of media items.

15. The system of claim 11, wherein the control circuitry is further configure to:
determine, for each feature attribute of the set of feature attributes, a predominance score; and
rank the plurality of media items based on the determined predominance score.

16. The system of claim 11, wherein the input/output circuitry is further configured to:
receive, from a database, user preferences;
wherein selecting the content item is further based on the user preferences.

17. The system of claim 16, wherein the user preferences include historical user information associated with the user device.

18. The system of claim 11, wherein the set of feature attributes is determined by:
determining, for each feature attribute of the set of feature attributes, a feature attribute score; and
ranking each feature attribute of the set of feature attributes according to the determined feature attribute score.

19. The system of claim 11, wherein the input/output circuitry is further configured to:
receive, from the content provider, a second contrast indicator that relates to a second feature attribute of the set of feature attributes;
wherein the selection of the content item is further based on the second contrast indicator.

20. The system of claim 19, wherein the first contrast indicator and the second contrast indicator relate to different modalities of feature attributes.
